(19) United States
(12) Patent Application Publication
(10) Pub. No.: US 2013/0132464 A1
(43) Pub. Date: May 23, 2013

(54) SYSTEMS AND METHODS FOR COMMUNICATION WITH A USER OF A SIMPLIFIED COMPUTING PLATFORM

(71) Applicant: Andrew James Dowling, Sydney (AU)

(72) Inventor: Andrew James Dowling, Sydney (AU)

(21) Appl. No.: 13/633,910

(22) Filed: Oct. 3, 2012

Related U.S. Application Data
(60) Provisional application No. 61/542,733, filed on Oct. 3, 2011.

(51) Int. Cl. H04L 29/06

(52) U.S. Cl. CPC H04L 67/42
USPC 709/203

(57) ABSTRACT

Described herein are systems and methods for providing simplified computing functionalities to a user. One embodiment provides a method for reporting on activity of a user of a simplified computing platform. The method includes making available at the simplified computing platform one or more normalised content items received from a data handling server. The data handling server is configured to receive data indicative of content items designated for display at the simplified computing platform, the data indicative of content items being received from a plurality of correspondents via a plurality of input channels. The server additionally normalises the content in accordance with a content normalisation protocol, and delivers the normalised content items for display at the simplified computing platform. An interface allows a user of the simplified computing platform make an interaction in respect of a given one of the content items.

### FIELD OF THE INVENTION

The present invention relates to systems and methods for communication with a user of a simplified computing platform, for example in terms of reporting on the activity of a user of a simplified computing platform, for example in terms of de-normalizing feedback provided in relation to content items viewed at the simplified computing platform. Whilst some embodiments will be described herein with particular reference to that application, it will be appreciated that the invention is not limited to such a field of use, and is applicable in broader contexts.

### BACKGROUND

Any discussion of the background art throughout the specification should in no way be considered as an admission that such art is widely known or forms part of common general knowledge in the field.

Advances in technology, for example in the context of computing platforms and social networking, provide difficulties to less computer literate segments of the community. Members of such segments are often deprived of the ability to keep in touch with others via such technologies, or otherwise derive the benefits of such technologies. This is particularity relevant given the wide range of content shared via the Internet, and the numerous channels used to share that content.

### SUMMARY OF THE INVENTION

It is an object of the present invention to overcome or ameliorate at least one of the disadvantages of the prior art, or to provide a useful alternative.

One embodiment provides a method for reporting on activity of a user of a simplified computing platform, the method including:

making available at the simplified computing platform one or more normalised content items received from a data handling server, wherein the data handling server is configured to:

receive data indicative of content items designated for display at the simplified computing platform, wherein the data indicative of content items is received from a plurality of correspondents via a plurality of input channels;

normalise the content in accordance with a content normalisation protocol; and

deliver the normalised content items for display at the simplified computing platform;

providing an interface thereby to allow a user of the simplified computing platform make an interaction in respect of a given one of the content items;

communicating to the data handling server data indicative of the interaction and data indicative of the content item in respect of which the interaction was made, such that the data handling server provides data indicative of the interaction to the correspondent from which the data item was received.

One embodiment provides a method for reporting on activity of a user of a simplified computing platform, the method including:

maintaining an account database, wherein the database includes records of account holders, wherein each account holder is associated with (i) a simplified computing platform; (ii) one or more subscribed observers; and (iii) one or more approved correspondents;

operating a content delivery module configured to:

receive from one of the approved correspondents data indicative of a content item for display at the simplified computing platform, wherein the data indicative of the content item is received from one of a plurality of input channels;

normalise the content item in accordance with a content normalisation protocol; and

deliver the normalised content item for display at the simplified computing platform; and

operating a monitoring module configured to:

receive data indicative of an interaction between the account holder and the content item via the simplified computing platform; and

provides data indicative of the interaction to the correspondent from which the data item was received and to the one or more subscribed observers.

One embodiment provides a computer system including a web server configured to deliver a web based interface to a plurality of user terminals, wherein the web server is configured to perform a method as described herein.

One embodiment provides a computer system including a microprocessor configured to perform a method as described herein.

One embodiment provides a tangible non-transient computer readable medium carrying executable code that when executed on one or more microprocessors of a computer system cause the computer system to perform a method as described herein.

One embodiment provides a computer program product configured for allowing the performance of a method as described herein.

Reference throughout this specification to “one embodiment”, “some embodiments” or “an embodiment” means that a particular feature, structure or characteristic described in connection with the embodiment is included in at least one embodiment of the present invention. Thus, appearances of the phrases “in one embodiment”, “in some embodiments” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

As used herein, unless otherwise specified the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

In the claims below and the description herein, any one of the terms comprising, comprised of or which comprises is an open term that means including at least the elements/features that follow, but not excluding others. Thus, the term comprising, when used in the claims, should not be interpreted as being limitative to the means or elements or steps listed thereafter. For example, the scope of the expression a device comprising A and B should not be limited to devices consisting only of elements A and B. Any one of the terms including or which includes or that includes as used herein is also an open term that also means including at least the elements/features that follow the term, but not excluding others. Thus, including is synonymous with and means comprising.

### BRIEF DESCRIPTION OF THE DRAWINGS

Preferred embodiments of the invention will now be described, by way of example only, with reference to the accompanying drawings in which:

FIG. 1 schematically illustrates a communications framework according to one embodiment.

FIG. 2 illustrates a simplified computing platform according to one embodiment.

FIG. 3 provides a system level overview according to one embodiment.

FIG. 4 illustrates an arrangement according to one embodiment.

FIG. 5 illustrates a method according to one embodiment.

FIG. 6 schematically illustrates a relationship framework for various embodiments.

FIG. 7 illustrates a system arrangement according to one embodiment.

### DETAILED DESCRIPTION

Described herein are systems and methods for providing simplified computing functionalities to a user. In overview, an arrangement is provided whereby a simplified computing device is provided to a user, for example a user with relatively low computer literacy. The device provides a user interface, which is remotely configurable by another user via a remote terminal. This in some embodiments is achieved by a web-based intermediary service, which may be a subscription-based service. In some embodiments the user interface is remotely configured to provide the user with simplified access to multimedia, messaging, and data obtained from social networking facilities. In some embodiments various forms of web content shared by various channels are normalized for display on the simplified computing device.

### General Framework

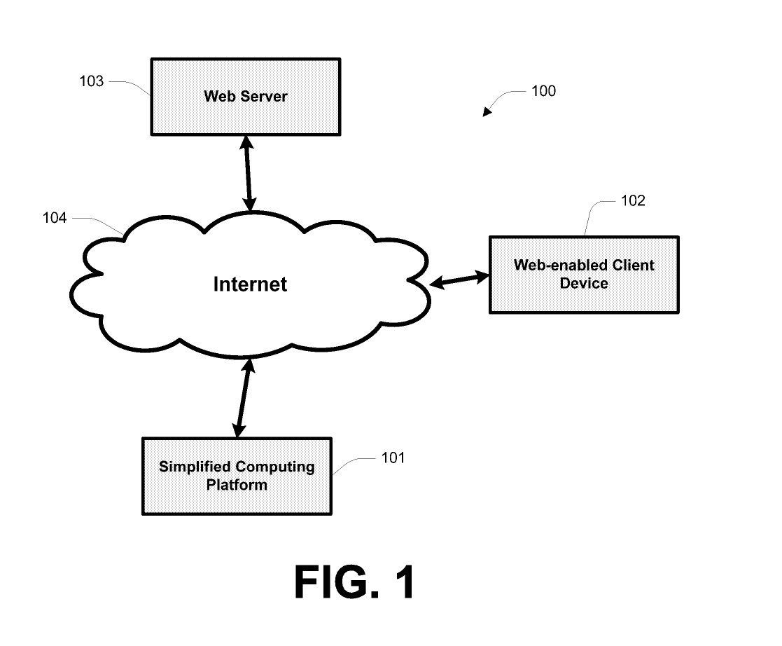

FIG. 1 provides a schematic overview of a general communications framework 100. A simplified computing platform 101, web-enabled client device 102, and web server 103 are all in communication via the Internet 104.

Simplified computing device 101 is preferably a tablet type device, and additional description of its makeup is provided further below. At a general level, device 101 is intended for use by relatively computer illiterate segments of the community, for example older people, mentally handicapped, and persons with relatively little experience using computers. Accordingly, the level of functionality provided is limited thereby to reduce complexity. A basic user interface executes by default on the device, this user interface providing simplified access to multimedia, messaging, and some data obtained from social networking facilities. In some embodiments additional functionality is provided, including functionality related to healthcare provision, and monitoring of wellbeing.

The user interface of device 101 is remotely configurable. That is, advanced aspects of computer configuration, management and the like are able to be conducted remotely. In the present embodiment this is achieved by web-enabled device 102, which may be a standard personal computer. A user of device 102 provides configuration instructions, which are transmitted to configure the user interface of device 101. In some embodiments this includes providing instructions to device 101. In other embodiments the configuration occurs at web server 103. For example, whereas in some cases the logic for driving various user interface functionalities of device 101 is provided locally at the device, in other embodiments the device operates as a thin client with that logic being maintained at web server 103.

At a practical level, one application for device 101 is for consumers to purchase device 101 for their parents. The consumers are able to remotely manage the operation of the device thereby to provide their parents with a simple computing platform that operates in a manner so as to allow the consumers to provide their parents with a desired level of functionality.

In some cases the device 101 is operated subject to a subscription-based service. This subscription preferably includes access to an Internet service provider, combined with access to services provided by server 103. In use, a subscription is preferably obtained prior to initial startup of device 101, which is subsequently commissioned (either pre-purchase or post purchase) to be associated with a resulting set of subscription data. Accordingly, once commissioned, the device is able to be turned on at which time it automatically connects to the Internet.

In some embodiments web server 103 provides users of devices 102 with a range of functionalities with which a particular device 101 may be configured. Examines include simple messaging services, access to news information, access to healthcare functionalities and the like, and simplified access to social networking.

In terms of social networking, one embodiment includes a method of receiving data from a social networking facility (such as Facebook or the like), modifying that data based on a set of user interface configuration data associated with a simplified computing platform, and delivering the modified data to a user of the simplified computing platform. For example, rather than requiring a user of platform 101 access a social networking site in the conventional manner, they are provided with a feed of data controlled by the party responsible for configuring device 101.

In one embodiment web server 103 provides an interface whereby third parties may be authorized to access functionality thereby to deliver specific content (such as messages, photos, and the like) to a specified device 101.

In some embodiments device 101 is configured to provide a “heartbeat” indicative of usage of the device, thereby to provide an indication of use. This is helpful in assessing the wellbeing of the user. For instance, by receiving acknowledgement that the user of device is active, interested parties are able to monitor health at a high level. In some embodiments device 101 is configurable to allow monitoring of specific health issues.

In some embodiments framework 100 provides two fundamental components:
A simplified touch-screen tablet device, and
An integrated social network.

These work in tandem to help seniors stay connected to their families. It does this by integrating a number of disparate capabilities, each of which on its own may not be new, but which are combined in original ways to create and reinforce connections between members of the network, specifically tailored to the needs of senior users. These features include but are not limited to:
The ability to share photos and videos by subscribing family members using any source (phone, camera, computer etc) which appear instantaneously on the photo frame device for viewing, browsing and management
Simplified communication features linked to the photo sharing capability providing bidirectional communication between network members, including both stateless (e.g. email) and real-time (e.g. live voice, live video, chat) mechanisms
Entertainment capabilities including games, e-books & magazines, applications, and other content
Integrated health and welfare monitoring and reporting, and integration with peripheral devices

These capabilities are tied together and linked to the social network to allow family members to both actively and passively care for senior relatives. The use of sharing or entertainment features, for example, is used as input data to the health and mood monitoring features, which provide early warning of problems related to physical and mental health.

The emphasis on connection extends to an innovative payment system, where subscription fees are borne by family members rather than the user of the device, with family members choosing how their contributions are manifested in the features available to the device user. This incorporates an advanced algorithm for optimizing contributions from family members based on usage and behavioral patterns.

The user interface of the device is designed to meet the specific needs of senior users, who may face difficulties with impaired vision, restricted movement and reduced ability to process complex, fast-changing information on-screen, and who are largely unfamiliar with existing computer user interface norms.

### Exemplary Device

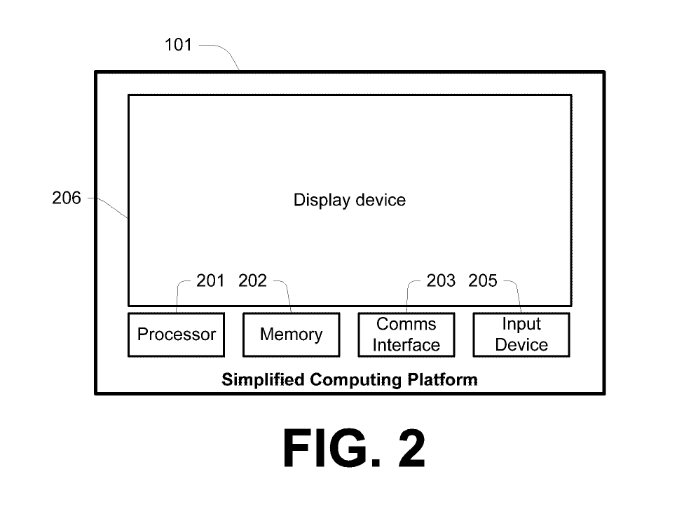

FIG. 2 illustrates a simplified computing platform 101 according to one embodiment. Device 101 includes a processor 201 coupled to a memory module 202 and a communications interface 203 (such as an internet connection, modem, Ethernet port, serial port, or the like), and input device 205 (including the likes of a touch screen and/or one or more buttons). Memory module 202 includes software instructions, which are executable on processor 201. These software instructions allow platform 101 to execute a software application, such as a proprietary application or web browser application and thereby render on-screen a user interface. This user interface allows for the creation, viewing and administration of profiles, access to the internal communications interface, and various other functionalities.

### Normalization of Incoming Data

In some embodiments, framework 100 is configured for normalizing content for display at a simplified computing platform. In overview, a wide range of forms of content (such as messages, media, links, and so on) are commonly shared via the Internet, over a wide range of sharing technologies (such as email, social networking sites such as Facebook and Google+, media sharing sites such as YouTube, Photobucket and Flickr). Framework 100 is configured to receive data from a range of sharing technologies, determine the form on content, and deliver it to simplified computing platforms in a normalized manner.

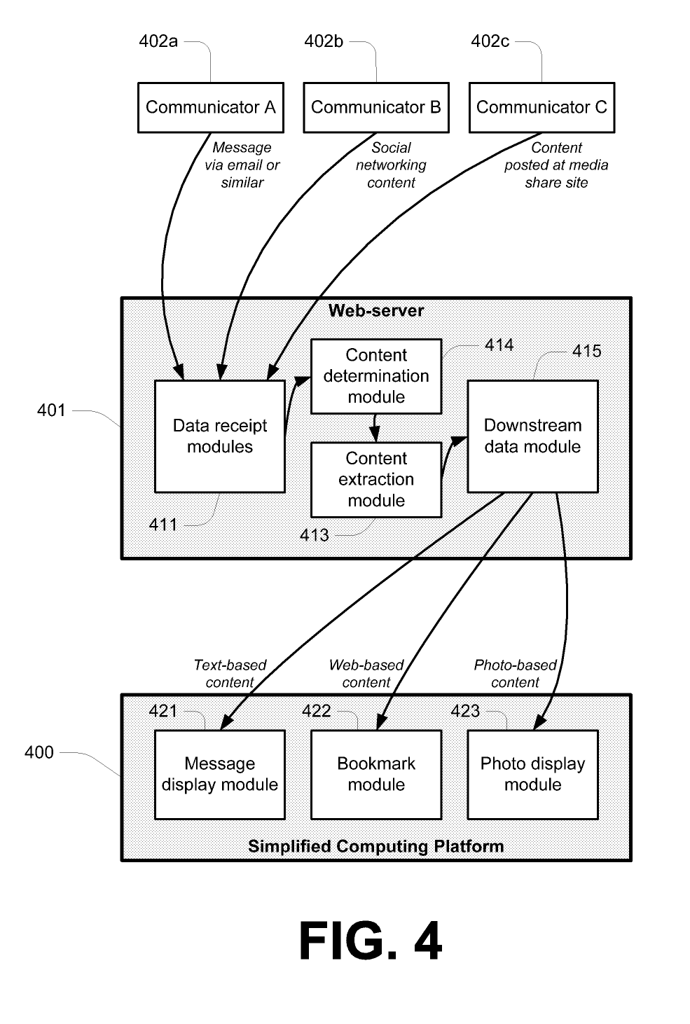

FIG. 4 illustrates an arrangement including a simplified computing platform 400, which communicates over the Internet with a simplified computing service provider web server 401. This web server is configured for normalizing content for provision to a plurality of simplified computing platforms (although only one is shown in FIG. 4).

In this example there are three communicators (402a, 402b and 402c). These communicators provide providing data including content intended for a user of a simplified computing platform, and may be physically defined by a substantially any computing platform (for example web servers, personal computers, portable devices, cellular telephones, and so on) or a user of any such computing platform. The communication channels intermediate the communicators and server 401 are simplified for the sake of convenient illustration, noting that there may be various intermediate devices responsible for passing data signals. It will be appreciated that in practice there may be a large number of communicators, in some cases favoring the use of multiple servers such as server 401 to handle the quantum of traffic.

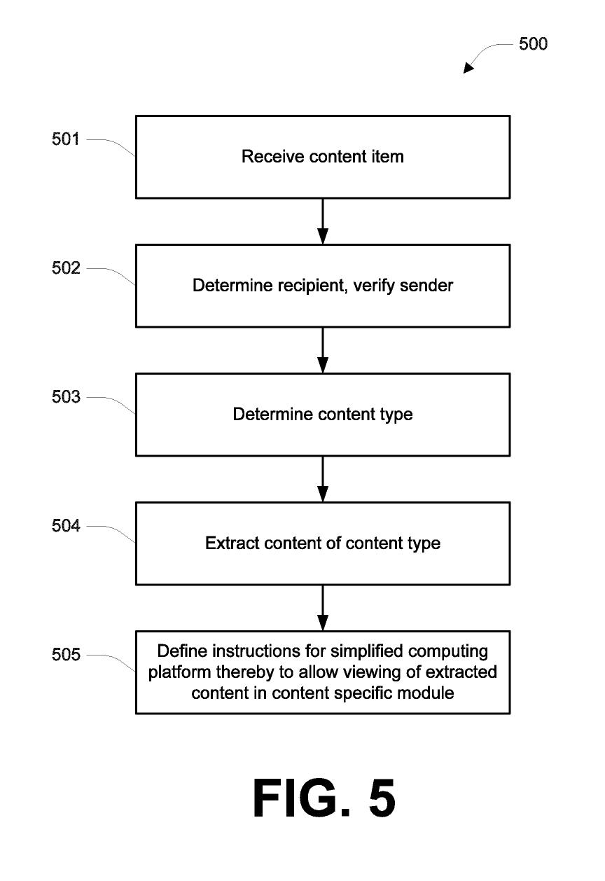

Server 401 is illustrated in terms of functionally defined modules. The operation of these modules is described by reference to method 500 of FIG. 5, which illustrates a method performed by server 401 according to one embodiment. It will be appreciated that in other embodiments method 500 is performed in whole or in part by a component other than server 401.

A plurality of data receipt modules are configured for receiving, via a respective plurality of input channels, data indicative of content for display at a simplified computing platform. In some cases the content is for display at a plurality of simplified computing platforms (for example where the data is addressed to multiple simplified computing platform users, or addressed to a user associated with multiple simplified computing platforms). The input channels may include any of the following:
Email. This may include emails sent to an address defined specifically for the purpose of receiving content for delivery to a simplified computing platform, or alternately a regular (for example pre-existing) email address. In the case of the latter, arrangements are made for mail delivered to/received at the regular email address to be delivered to server 401. One or more of modules 411 is configured to receive data indicative of such emails.
Other forms of messaging. This may include messages transmitted via instant messaging services, via messaging interfaces provided by various web facilities (such as messaging facilities in social network facilities), SMS/MMS messaging, and so on. Once again, where appropriate message forwarding protocols are implemented. One or more of modules 411 is configured to receive data indicative of such messages.
Posts made via a social networking facility. The term “post”, in this context, should be read broadly and describes substantially any form of content shared via a social networking facility. One or more of modules 411 is configured to receive data indicative of such posts. In some embodiments a plugin or the like is used to modify the operation of a social networking facility user's account settings thereby to allow integration with server 401. For example, in some cases an option is provided to automatically share certain categories of posts with specified users of simplified computing platforms. In some cases such an option is provided on a post-by-post basis. Some embodiments use social networking facility notifications, “tagging”, and the like is leveraged to identify data indicative of content that is intended for the user of a simplified computing platform.
Content shared via a content sharing facility. Content sharing facilities (such as Youtube and Flickr) allow users to share content, such as photo albums, videos, and so on. One or more of modules 411 is configured to receive data indicative of such content.

In the context of method 500, data indicative of content is received via a given one of input channels at 501. Each instance is processed at 502 thereby to determine one or more intended recipients, each recipient being a registered user of a simplified computing platform 400. This is used to determine to which platform 400 the content is to be delivered. In some cases a given user is associated with a plurality of simplified computing platforms, in which case it is determined that the relevant content is to be delivered to that plurality of platforms. The precise nature of step 501 depends on the nature of data received. For example, in the case of an email or other message, an intended recipient is inherently identifiable. In some cases the data is inherently indicative of a recipient (for example by embedding a recipient ID in the data), or a indicative of a sender associated with one or more recipients (i.e. the recipient or recipients are identified based on the identity of the sender).

In some cases the sender's identify is verified, thereby to restrict communication with platform 400 to approved senders.

A content determination module is configured for processing received data thereby to determine a primary content type at 503. Once the primary content type is determined, a content extraction module extracts content of the primary content type from the received data. This may include a single content item, or multiple content items. The primary content type is identified from a predefined selection of primary content types, each content type having an associated software module installed at simplified computing platform 400 configured specifically for the display of content of that primary content type. In some cases not all platforms 400 have the same software modules installed; accordingly in some embodiments server 401 maintain access to data indicative of applications installed on the platform or platforms to which a particular instance of data is directed thereby to influence the determination of a primary content type. Preferably, however, there is a limited set of possible primary content types (preferably between 3 and 8), each being associated with a respective software application installed at each platform 400. For example, any of the following may apply:
The primary content type is images, and the associated software module is an image display module 423.
The primary content type is text, in which case the associated software module is a message display module 421.
The primary content type is a web address, in which case the associated software module may be a web browser application having bookmark storage functionality 422. Preferably, however, web addresses are handled based on the form of content they access. For example, a web address that links to an image is preferably handled as an image rather than a bookmark.

It will be appreciated that the primary content type may be other forms of media, in which case the associated software module is a software application configured to display the relevant form of other media. In some cases the primary content type may include an application that is installable and executable on platform 400.

Various examples of content extraction approaches are outlined below. It will be appreciated that these are not intended to be necessarily limiting or exclusive.
In some cases, where the received data is indicative of a web address that links to an image or a page containing one or more images, the primary content type is determined to be “images” and the image or images are made available for display in the image display module. That is, although the data is in essence a web address, rather than treating that as a bookmark for a web browser, the web addresses is processed based on a set of rules thereby to determine whether the link represents another content type (such as images). In some such cases extracting the image or images includes downloading the image or images from the web address, and the method further includes transmitting the image or images to the simplified computing platform. In other cases the image display module is configured to transparently access links to images rather, negating the need for image download (noting that download may be challenging for some content sharing facilities). In some cases, web addresses are assessed, and a determination is made to treat them as bookmarks intended to be accesses by the user of a platform 400.
In some cases the data is an email, and the primary content type is determined to be an image (for example an image attached to the email). The one or more images are extracted from the email and made available for display via a software module configured specifically for the display of images. That is, rather than treating such an email as an email per se, and making it available in a messaging application, primary content is extracted and treaded appropriately thereby to simplify computing for the end user (e.g. emailed photos automatically appear in the user's photo album).
In some cases, the data is an email, and the primary content type is determined to be a text-based message, such that one or more images are extracted from the email and made available for display via a non-email text-based message software module. In this manner, the user is presented with a non-email text-based message software module, which is able to be significantly simpler than a conventional email interface.
In some cases the data is indicative of a post made via a social networking facility, and the method includes extracting the one or more content items from the social networking facility. For example the one or more content items extracted from the social networking facility are determined to have a primary content type of image, such that one or more images are extracted from the social networking facility and made available for display via a software module configured specifically for the display of images. In other cases text-based posts are extracted and delivered for display via the messaging module.

A downstream messaging module 414 is configured for defining and delivering a signal to the relevant a simplified computing platform (or platforms) associated with the identified account holder, thereby instruct the simplified computing platform for make the one or more content items available for display via a software module configured specifically for the display of content of the primary content type. This occurs at step 505 of FIG. 5.

Normalization as discussed above is particularly useful in the context of providing simplified computing functionalities. In particular, a user of a simplified computing platform is able to experience content from a wide range of sources whilst only using a small number of content-specific software modules.

### Account Framework

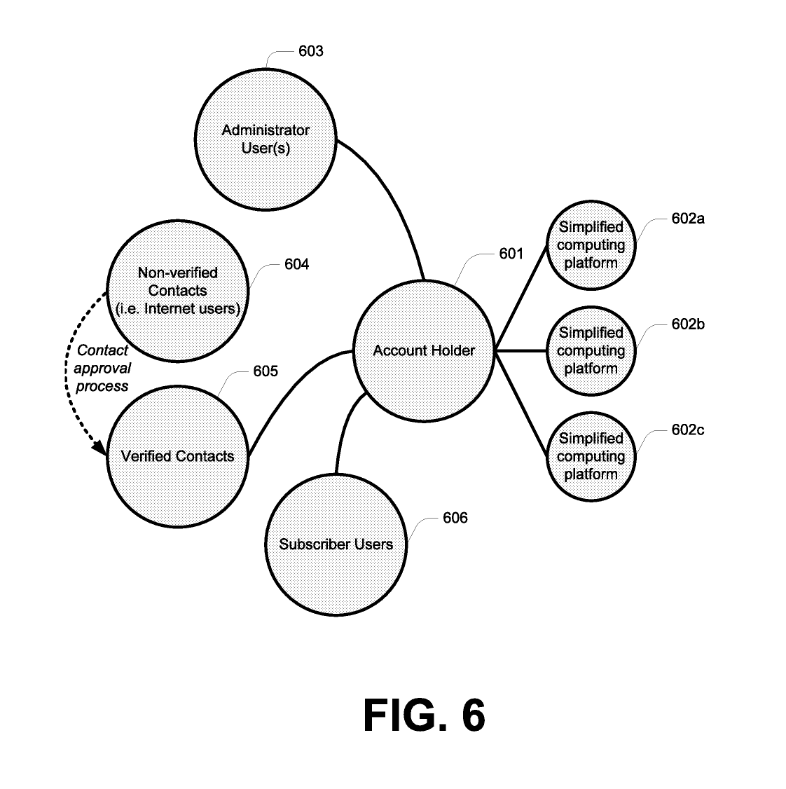

FIG. 6 provides a conceptual overview of those parties who participate in an environment including simplified computing platforms as described herein, according to various embodiments. A logical starting point is an account holder 601, being the person for whom a particular simplified computing platform is intended (also referred to as the “user” of a simplified computing platform, although noting that in practice a person other than the account holder could in theory use the platform). In some cases a simplified computing platform is purchased on behalf of account holder 601 (for example a relative), and initially configured by the purchaser on behalf of the account holder.

Each account holder 601 has a unique identifier. Each identifier (and hence the respective account holder) is associated with one or more simplified computing platforms (602a-c), for example based on contact addresses and or device IDs associated with those platforms. In this manner, the account holder is able to have a single platform, or multiple platforms. In the case of multiple platforms, data is preferably correspondingly pushed to each of the platforms, and other steps taken, thereby to synchronize data (and settings, etc.) across the platforms. In some embodiments synchronization is performed such that an account holder is able to move between usage of one of his/her associated platforms (e.g. platform 602a) to another (e.g. platform 602b) seamlessly, such that from the user experience perspective it feels as though the same device is being used throughout. For example, one approach is to communicate device activity to a central server such that data indicative of a runtime state is centrally maintained, and that runtime state adopted by another platform upon resumption of active use. However, in other embodiments it is sufficient that all of an account holder's associated devices maintain common data and settings.

Each account holder 601 is associated with at least one administrator user 603 (which at a practical level may be a relative who purchased and pre-configured the platform for the account holder. An administrator user is able to log onto a predefined website using user-specific credentials thereby to access administrator level access to the simplified computing platform(s) associated with account holder 601, for example to modify settings, install applications, manage contact approvals, and so on. Administrator user 603 is additionally in some embodiments responsible for paying a subscription fee thereby to keep the simplified computing platforms associated with account holder 601 active in terms of the online framework. In some cases there are multiple levels of administrator user, with respective levels of permission to perform actions in relation to the simplified computing platform(s). At a practical level, in some cases the administrator users include a family member of account holder 601 who is relatively more tech savvy (such as a child or grandchild who purchases the platform as a gift for the account holder).

Non-verified contacts 604 define substantially any Internet users with email addresses, social network identities, or the like. Such users are able undergo a contact approval process (discussed further below) thereby to become verified contacts 605. Verified contacts are able to provide data indicative of content items (such as messages, bookmarks, photos, and so on) for normalization and delivery to the platform(s) associated with account holder 601 as discussed further above.

In some embodiments there are also subscriber users 606, who may or may not wish to provide data to account holder 601, but nevertheless register to receive notifications regarding the activity of account holder 601. For example, these users are in some embodiments able to view comments made by account holder 601 in respect of content items viewed by account holder 601, and/or view statistics regarding the utilization of platforms 602a-c (and hence perform a degree of passive monitoring of account holder 601, which may be useful in terms of monitoring health). It will be appreciated that a given user may be any two or more of a user 603, 605 and 606. For example, an administrator user is in many cases also a verified contact and a subscriber.

### Contact Approval Process

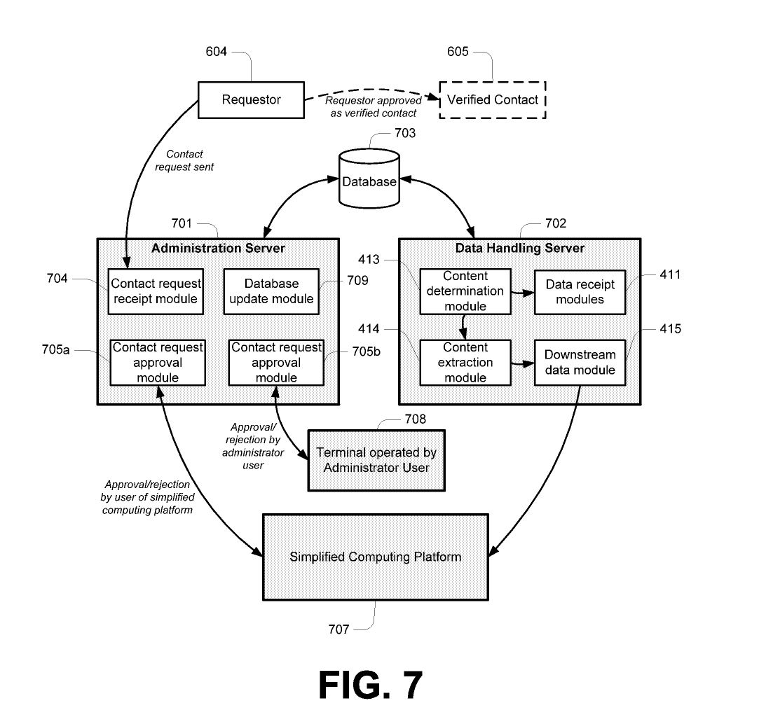

It will be appreciated that, in the context of a simplified computing platform as described herein, there are advantages associated with carefully managing from whom a user of a simplified computing platform receives data. A method for processing a contact request is described by reference to FIG. 7A.

FIG. 7 illustrates an administration server 701 and a data handling server 702. It should be appreciated that in some embodiments the functionalities of these servers are performed by common hardware (or by a common set of distributed hardware resources) and that the illustrated distinction of primarily for the purposes of convenient explanation. Both servers leverage a common database 703, which includes details for users, for example in accordance with the framework described in connection with the example of FIG. 6.

Administration server 701 includes a contact request module 704 that is configured to provide a contact request interface configured to receive data indicative of a contact requests from respective requestors, being unverified contacts 604. The contact request interface is preferably provided via a web-server arrangement, defined by various objects renderable in a web-page. Each contact request is associated with the respective requestor and associated with an account holder 601 specified by the requestor. In some cases the account holder is “specified” implicitly by the context of the request.

Administration server 701 includes contact request approval modules 705a and 705b that are configured to provide respective contact request approval interfaces, thereby to allow selective approval of a given contact request by or on behalf of the associated account holder. Specifically, module 705a is configured to permit approval of a contact request by a user of simplified computing platform 707 (typically being account holder 601) whereas module 705b is configured to permit approval of a contact request by an administrator user 603 over the Internet via a web interface or the like. In some cases approval via the simplified computing platform is disabled thereby to further simplify operation of that device.

In the case that the given contact request is approved, server 701 is configured to define the requestor as a verified contact 605 for account holder 601 by updating database 703, via a database update module 708. This in essence configures data handling server 702 to receive data indicative of content designated by the verified contact for display at the simplified computing associated with the account holder, normalise the content in accordance with a content normalisation protocol as discussed further above, and deliver the normalised content for display at the simplified computing platform (also as discussed further above). To this end, in FIG. 7A, server 702 is illustrated as including modules 411, 413, 414 and 415.

### Feedback Normalisation/Denormalisation

As noted above, technologies and methodologies described herein are configured to make available at a simplified computing platform one or more normalised content items received from a data handling server. Such a data handling server is configured to receive data indicative of content items designated for display at the simplified computing platform, wherein the data indicative of content items is received from a plurality of correspondents via a plurality of input channels, normalise the content in accordance with a content normalisation protocol, and deliver the normalised content items for display at the simplified computing platform. It will be appreciated that such data handling is, in essence, downstream communication. The following section is concerned with the handling of upstream communication, being communications initiated by activity between a user of a simplified computing platform and a content item.

In overview, the simplified computing platform allows a user (generally assumed to be the account holder) to make an interaction in respect of a given one of the content items. An interaction may include viewing a content item, or providing feedback in relation to a content item. The concept of “providing feedback” may include commenting on a photo, video or bookmark, responding to a text based message, and so on. Where an interaction is made, the simplified computing platform is configured to communicate to the data handling server data indicative of the interaction and data indicative of the content item in respect of which the interaction was made. This enables the data handling server to provide data indicative of the interaction to the correspondent from which the data item was received.

In some cases the data handling server provides data indicative of the interaction to the correspondent from which the data item was received via the same input channel via which the content item was received (i.e. feedback de-normalisation). For example, in the case that the content item is a photo originating from Facebook, and the account holder makes a comment, that comment is communicated to the user via the Facebook messaging facility. If the content item was provided via an email address, the feedback is provided to that same email address. Feedback de-normalisation in essence operates such that content items are received via a range of communication channels and normalized for display at the simplified computing platform, whereas feedback is received in a normalized format via the simplified computing platform and delivered to the provider of the content item via any of the range of communications channels (preferably being the channel used to provide the content item in the first instance). It will be appreciated that this in some cases necessitates a degree of interaction between a data handling server and each of the communications channels (for example to allow the provisional of feedback via Facebook or a media sharing facility).

In some embodiments the data handling server provides data indicative of the interaction to the correspondent from which the data item was received via an input channel other than the input channel via which the content item was received, such as a normalized channel by which a correspondent receives all feedback provided in respect of content items, regardless of the communications channels used to provide those content items (i.e. feedback normalization). For example, in some embodiments all feedback is provided via a common channel (such as an email address), even though content items may be provided by a range of communications channels. For example, using the Facebook photo example, server 702 defines and sends an email to the originator of the content item, that email including data indicative of the content item and the feedback provided. In some embodiments a response to this email is processed by data server 702 thereby to associate the response with the relevant content item at the simplified computing platform (e.g. a user is able to view feedback, feedback responses, and any further resulting conversation) in association with the content item.

In some embodiments the data handling server provides data indicative of the interaction to the correspondent from which the data item was received and to one or more other correspondents subscribed to receive notifications in respect of the user of the simplified computing platform, being subscribers 606. This may include email notifications. In some embodiments each account holder has an outward facing public profile which is viewable online by subscribers 606 which shows predetermined forms of content items (such as photos) on which the account holder has commented, along with those comments. In some embodiments the originator of the content item determines whether that content item is to appear on the outward facing public profile. This approach in effect allows an account holder to maintain a form of blog which reports on interaction between the account holder and his/her verified contacts. It will be appreciated that this is particularly useful in contexts where the simplified computing platform is implemented as a means for keeping contact between a non-tech-savvy family member and other tech-savvy family members.

In some embodiments data indicative of interactions is provided to subscribers 606 in the form of a periodic activity report for the simplified computing platform. For example, such a report may show whether interactions are being made regularly, thereby providing a form of passive monitoring (which may be indicative of ill-health where interactions cease). In some cases a predetermined period with no interactions being made causes an alarm to be raised and one or more administrators 603 notified. In some cases periodic activity reports are configured to additionally or alternately allow an administrator to determine how the platform is being used.

### Exemplary System-Level Overview

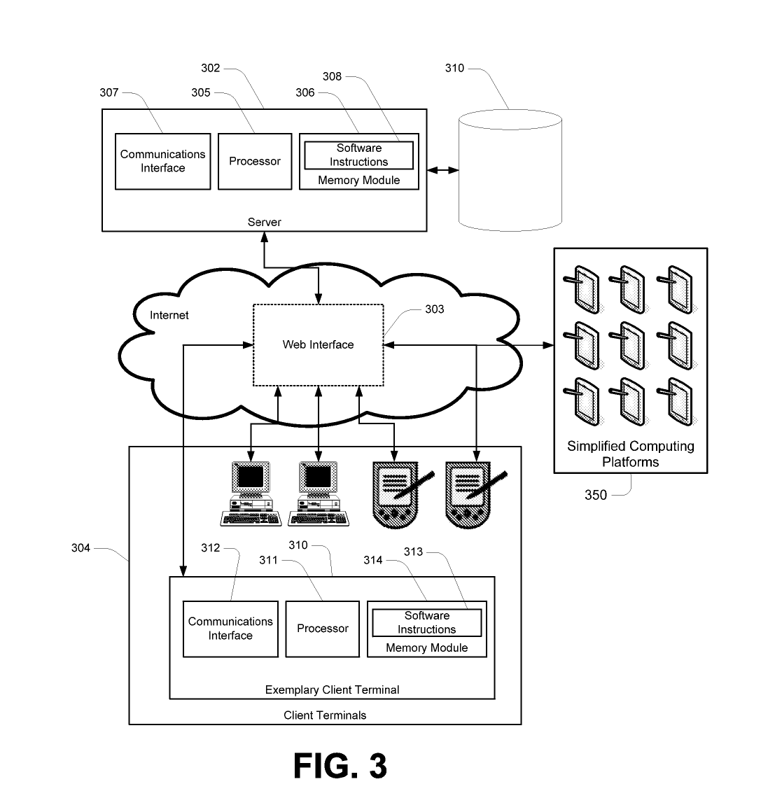

In some embodiments, methods and functionalities considered herein are implemented by way of a server, as illustrated in FIG. 3. In overview, a web server 302 provides a web interface 303. This web interface is accessed by the parties by way of client terminals 304. In overview, users access interface 303 over the Internet by way of client terminals 304, which in various embodiments include the likes of personal computers, PDAs, cellular telephones, gaming consoles, and other Internet enabled devices. A group 350 of devices 101 also communicate with web server 302.

Server 302 includes a processor 305 coupled to a memory module 306 and a communications interface 307, such as an Internet connection, modem, Ethernet port, wireless network card, serial port, or the like. In other embodiments distributed resources are used. For example, in one embodiment server 302 includes a plurality of distributed servers having respective storage, processing and communications resources. Memory module 306 includes software instructions 308, which are executable on processor 305.

Server 302 is coupled to a database 310 (which may provide the functionality of any one or more of databases 103, 105 and 106), which in some embodiments includes a plurality of distributed storage locations. In further embodiments the database leverages memory module 306. Database 310 maintains a data indicative of employer profiles and jobseeker profiles (including data for allowing the viewing of both public and private profiles).

In some embodiments web interface 303 includes a website. The term “website” should be read broadly to cover substantially any source of information accessible over the Internet or another communications network (such as WAN, LAN or WLAN) via a browser application running on a client terminal. In some embodiments, a website is a source of information made available by a server and accessible over the Internet by a web-browser application running on a client terminal. The web-browser application downloads code, such as HTML code, from the server. This code is executable through the web-browser on the client terminal for providing a graphical and often interactive representation of the website on the client terminal. By way of the web-browser application, a user of the client terminal is able to navigate between and throughout various web pages provided by the website, and access various functionalities that are provided.

Although some embodiments make use of a website/browser-based implementation, in other embodiments proprietary software methods are implemented as an alternative. For example, in such embodiments client terminals 304 maintain software instructions for a computer program product that essentially provides access to a portal via which framework 100 is accessed (for instance via an iPhone app or the like).

In general terms, each terminal 304 includes a processor 311 coupled to a memory module 313 and a communications interface 312, such as an internet connection, modem, Ethernet port, serial port, or the like. Memory module 313 includes software instructions 314, which are executable on processor 311. These software instructions allow terminal 304 to execute a software application, such as a proprietary application or web browser application and thereby render on-screen a user interface and allow communication with server 302. This user interface allows for the creation, viewing and administration of profiles, access to the internal communications interface, and various other functionalities.

Unless specifically stated otherwise, as apparent from the following discussions, it is appreciated that throughout the specification discussions utilizing terms such as “processing,” “computing,” “calculating,” “determining”, analyzing” or the like, refer to the action and/or processes of a computer or computing system, or similar electronic computing device, that manipulate and/or transform data represented as physical, such as electronic, quantities into other data similarly represented as physical quantities.

In a similar manner, the term “processor” may refer to any device or portion of a device that processes electronic data, e.g., from registers and/or memory to transform that electronic data into other electronic data that, e.g., may be stored in registers and/or memory. A “computer” or a “computing machine” or a “computing platform” may include one or more processors.

The methodologies described herein are, in one embodiment, performable by one or more processors that accept computer-readable (also called machine-readable) code containing a set of instructions that when executed by one or more of the processors carry out at least one of the methods described herein. Any processor capable of executing a set of instructions (sequential or otherwise) that specify actions to be taken are included. Thus, one example is a typical processing system that includes one or more processors. Each processor may include one or more of a CPU, a graphics processing unit, and a programmable DSP unit. The processing system further may include a memory subsystem including main RAM and/or a static RAM, and/or ROM. A bus subsystem may be included for communicating between the components. The processing system further may be a distributed processing system with processors coupled by a network. If the processing system requires a display, such a display may be included, e.g., a liquid crystal display (LCD), LED, display or a cathode ray tube (CRT) display. If manual data entry is required, the processing system also includes an input device such as one or more of an alphanumeric input unit such as a keyboard, a pointing control device such as a mouse, and so forth. The term memory unit as used herein, if clear from the context and unless explicitly stated otherwise, also encompasses a storage system such as a disk drive unit. The processing system in some configurations may include a sound output device, and a network interface device. The memory subsystem thus includes a computer-readable carrier medium that carries computer-readable code (e.g., software) including a set of instructions to cause performing, when executed by one or more processors, one of more of the methods described herein. Note that when the method includes several elements, e.g., several steps, no ordering of such elements is implied, unless specifically stated. The software may reside in the hard disk, or may also reside, completely or at least partially, within the RAM and/or within the processor during execution thereof by the computer system. Thus, the memory and the processor also constitute computer-readable carrier medium carrying computer-readable code.

Furthermore, a computer-readable carrier medium may form, or be included in a computer program product.

In alternative embodiments, the one or more processors operate as a standalone device or may be connected, e.g., networked to other processor(s), in a networked deployment, the one or more processors may operate in the capacity of a server or a user machine in server-user network environment, or as a peer machine in a peer-to-peer or distributed network environment. The one or more processors may form a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine.

Note that while diagrams only show a single processor and a single memory that carries the computer-readable code, those in the art will understand that many of the components described above are included, but not explicitly shown or described in order not to obscure the inventive aspect. For example, while only a single machine is illustrated, the term “machine” shall also be taken to include any collection of machines that individually or jointly execute a set (or multiple sets) of instructions to perform any one or more of the methodologies discussed herein.

Thus, one embodiment of each of the methods described herein is in the form of a computer-readable carrier medium carrying a set of instructions, e.g., a computer program that is for execution on one or more processors, e.g., one or more processors that are part of web server arrangement. Thus, as will be appreciated by those skilled in the art, embodiments of the present invention may be embodied as a method, an apparatus such as a special purpose apparatus, an apparatus such as a data processing system, or a computer-readable carrier medium, e.g., a computer program product. The computer-readable carrier medium carries computer readable code including a set of instructions that when executed on one or more processors cause the processor or processors to implement a method. Accordingly, aspects of the present invention may take the form of a method, an entirely hardware embodiment, an entirely software embodiment or an embodiment combining software and hardware aspects. Furthermore, the present invention may take the form of carrier medium (e.g., a computer program product on a computer-readable storage medium) carrying computer-readable program code embodied in the medium.

The software may further be transmitted or received over a network via a network interface device. While the carrier medium is shown in an exemplary embodiment to be a single medium, the term “carrier medium” should be taken to include a single medium or multiple media (e.g., a centralized or distributed database, and/or associated caches and servers) that store the one or more sets of instructions. The term “carrier medium” shall also be taken to include any medium that is capable of storing, encoding or carrying a set of instructions for execution by one or more of the processors and that cause the one or more processors to perform any one or more of the methodologies of the present invention. A carrier medium may take many forms, including but not limited to, non-volatile media, volatile media, and transmission media. Non-volatile media includes, for example, optical, magnetic disks, and magneto-optical disks. Volatile media includes dynamic memory, such as main memory. Transmission media includes coaxial cables, copper wire and fiber optics, including the wires that comprise a bus subsystem. Transmission media also may also take the form of acoustic or light waves, such as those generated during radio wave and infrared data communications. For example, the term “carrier medium” shall accordingly be taken to included, but not be limited to, solid-state memories, a computer product embodied in optical and magnetic media; a medium bearing a propagated signal detectable by at least one processor of one or more processors and representing a set of instructions that, when executed, implement a method; and a transmission medium in a network bearing a propagated signal detectable by at least one processor of the one or more processors and representing the set of instructions.

It will be understood that the steps of methods discussed are performed in one embodiment by an appropriate processor (or processors) of a processing (i.e., computer) system executing instructions (computer-readable code) stored in storage. It will also be understood that the invention is not limited to any particular implementation or programming technique and that the invention may be implemented using any appropriate techniques for implementing the functionality described herein. The invention is not limited to any particular programming language or operating system.

### Conclusions

It will be appreciated that the disclosure above provides various novel and inventive systems and methods for reporting on the activity of a user of a simplified computing platform, for example in terms of de-normalizing feedback provided in relation to content items viewed at the simplified computing platform. It should be appreciated that in the above description of exemplary embodiments of the invention, various features of the invention are sometimes grouped together in a single embodiment, FIG., or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Furthermore, some of the embodiments are described herein as a method or combination of elements of a method that can be implemented by a processor of a computer system or by other means of carrying out the function. Thus, a processor with the necessary instructions for carrying out such a method or element of a method forms a means for carrying out the method or element of a method. Furthermore, an element described herein of an apparatus embodiment is an example of a means for carrying out the function performed by the element for the purpose of carrying out the invention.

In the description provided herein, numerous specific details are set forth. However, it is understood that embodiments of the invention may be practiced without these specific details. In other instances, well-known methods, structures and techniques have not been shown in detail in order not to obscure an understanding of this description.

Similarly, it is to be noticed that the term coupled, when used in the claims, should not be interpreted as being limited to direct connections only. The terms “coupled” and “connected,” along with their derivatives, may be used. It should be understood that these terms are not intended as synonyms for each other. Thus, the scope of the expression a device A coupled to a device B should not be limited to devices or systems wherein an output of device A is directly connected to an input of device B. It means that there exists a path between an output of A and an input of B which may be a path including other devices or means. “Coupled” may mean that two or more elements are either in direct physical or electrical contact, or that two or more elements are not in direct contact with each other but yet still co-operate or interact with each other.

Thus, while there has been described what are believed to be the preferred embodiments of the invention, those skilled in the art will recognize that other and further modifications may be made thereto without departing from the spirit of the invention, and it is intended to claim all such changes and modifications as fall within the scope of the invention. For example, any formulas given above are merely representative of procedures that may be used. Functionality may be added or deleted from the block diagrams and operations may be interchanged among functional blocks. Steps may be added or deleted to methods described within the scope of the present invention.

1. A method for reporting on activity of a user of a simplified computing platform, the method including:
making available at the simplified computing platform one or more normalised content items received from a data handling server, wherein the data handling server is configured to:
(i) receive data indicative of content items designated for display at the simplified computing platform, wherein the data indicative of content items is received from a plurality of correspondents via a plurality of input channels;
(ii) normalise the content in accordance with a content normalisation protocol; and
(iii) deliver the normalised content items for display at the simplified computing platform;
providing an interface thereby to allow a user of the simplified computing platform make an interaction in respect of a given one of the content items;
communicating to the data handling server data indicative of the interaction and data indicative of the content item in respect of which the interaction was made, such that the data handling server provides data indicative of the interaction to the correspondent from which the data item was received.

2. A method according to claim 1 wherein the interaction includes any one of: viewing the content item; providing feedback in relation to the content item; and providing a message in response to the content item.

3. A method according to claim 1 or claim 2 wherein the data handling server provides data indicative of the interaction to the correspondent from which the data item was received via the same input channel via which the content item was received.

4. A method according to claim 1 or claim 2 wherein the data handling server provides data indicative of the interaction to the correspondent from which the data item was received via an input channel other than the input channel via which the content item was received.

5. A method according to any preceding claim wherein the data handling server provides data indicative of the interaction to the correspondent from which the data item was received and to one or more other correspondents subscribed to receive notifications in respect of the user of the simplified computing platform.

6. A method for reporting on activity of a user of a simplified computing platform, the method including:
maintaining an account database, wherein the database includes records of account holders, wherein each account holder is associated with (i) a simplified computing platform; (ii) one or more subscribed observers; and (iii) one or more approved correspondents;
operating a content delivery module configured to:
(i) receive from one of the approved correspondents data indicative of a content item for display at the simplified computing platform, wherein the data indicative of the content item is received from one of a plurality of input channels;
(ii) normalise the content item in accordance with a content normalisation protocol; and
(iii) deliver the normalised content item for display at the simplified computing platform; and
operating a monitoring module configured to:
(i) receive data indicative of an interaction between the account holder and the content item via the simplified computing platform; and
(ii) provides data indicative of the interaction to the correspondent from which the data item was received and to the one or more subscribed observers.

7. A method according to claim 6 wherein the interaction includes any one of: viewing the content item; providing feedback in relation to the content item; and providing a message in response to the content item.

8. A method according to claim 6 or claim 7 including providing the data indicative of the interaction to the correspondent from which the data item was received via the same input channel via which the content item was received.

9. A method according to claim 6 or claim 7 including providing the data indicative of the interaction to the correspondent from which the data item was received via an input channel other than the input channel via which the content item was received.

10. A method according to any one of claims 6 to 9 the data indicative of the interaction to provided to the one or more subscribed observers is in the form of a periodic activity report for the simplified computing platform.

11. A computer system including a microprocessor configured to perform a method according to any one of claims 1 to 10.

12. A tangible non-transient computer readable medium carrying executable code that when executed on one or more microprocessors of a computer system cause the computer system to perform a method according to any one of claims 1 to 10.

13. A computer program product configured for allowing the performance of a method according to any one of claims 1 to 10.

14. A system, device or method substantially as herein described with reference to any one of the embodiments of the invention illustrated in the accompanying drawings and/or examples.
